(19) United States
(12) Patent Application Publication
(10) Pub. No.: US 2026/0131529 A1
(43) Pub. Date: May 14, 2026

(54) METHODS AND DEVICES FOR POST-PROCESSING 3D PRINTED MICROFLUIDIC DEVICES

(71) Applicant: Board of Regents, The University of Texas System, Austin, TX (US)

(72) Inventors: Gabriel Garibaldi, San Antonio, TX (US); Guillermo Ramirez, San Antonio, TX (US); Gongchen Sun, San Antonio, TX (US)

(21) Appl. No.: 19/267,541

(22) Filed: Jul. 12, 2025

Related U.S. Application Data
(60) Provisional application No. 63/670,719, filed on Jul. 12, 2024.

(51) Int. Cl. B29C 64/188; B29C 64/129; B29C 64/241; B29C 64/245; B29C 64/25; B29C 64/264; B29C 64/364; B29C 64/393; B29L 31/00; B33Y 10/00; B33Y 30/00; B33Y 40/20; B33Y 50/02

(52) U.S. Cl. CPC B29C 64/188; B29C 64/241; B29C 64/245; B29C 64/25; B29C 64/264; B29C 64/364; B29C 64/393; B29C 64/129; B29L 2031/756; B33Y 10/00; B33Y 30/00; B33Y 40/20; B33Y 50/02

(57) ABSTRACT

Aspects are directed to methods and devices for post-manufacture processing of 3D printed microfluidic manufactures, resulting in the fabrication of transparent microfluidic chips. The methods include inserting a prepared build plate into a post-processing device, which integrates a brushless DC motor-driven rotating platform within a vacuum-sealed, desiccator. The rotating platform, equipped with a custom 3D-printed Motor-to-Chuck Connector and chuck, spins to apply centrifugal force, removing excess uncured resin while creating a smooth print surface. A UV LED light cures the device in a low-oxygen environment, facilitated by a vacuum source. A custom Graphic User Interface (GUI) provides precise control over spin rate and processing time, enhancing automation and reproducibility. This solvent-free method achieves superior optical transparency, making it suitable for high-resolution microfluidic applications in bioengineering, medical, and pharmaceutical fields.

### RELATED APPLICATION

This Application is a US Utility Application claiming priority to U.S. Provisional Patent Application No. 63/670,719 filed on Jul. 12, 2024 which is incorporated herein by reference in its entirety.

### STATEMENT REGARDING FEDERALLY FUNDED RESEARCH

None.

### FIELD

Aspects of the invention are directed to the field of manufacturing, and in particular to three-dimensional (3D) printing of microfluidic devices.

### BACKGROUND

The market size for microfluidic research is projected to grow significantly in the coming years. The global microfluidics market size was estimated at USD 32.15 billion in 2023 and is expected to grow at a compound annual growth rate (CAGR) of 12.22% from 2024 to 2030. However, other projections suggest the market will reach USD 89.5 billion by 2032, exhibiting a CAGR of 13.1% during 2024-2032. Additionally, estimates indicate the market size will be USD 32.58 billion in 2024, reaching USD 64.94 billion by 2029, growing at a CAGR of 14.79% during this forecast period (2024-2029).

The growth of the microfluidics market is driven by several factors, including the increasing demand for point-of-care testing, the rising prevalence of infectious and chronic diseases, and the advantages of microfluidic devices, such as rapid and precise response, cost-effectiveness, and portability. The market is also experiencing a surge in the adoption of lab-on-chip devices and microfluidic components for various applications in scientific research and clinical diagnostics.

North America is expected to dominate the market during the forecast period due to factors such as its well-established healthcare system, higher adoption of novel therapeutics, and significant investment in research and development. The Asia Pacific region is also expected to witness high growth rates due to its sophisticated research infrastructure, developing economies, and affordable labor.

There is a need for more efficient methods for processing of microfluidic devices.

### SUMMARY

The Spinning Desiccating Curing (desicurer) method is a solvent-free, cost-effective, and generalizable post-processing method for 3D printed microfluidics.

Certain embodiments are directed to devices and methods for post-printing processing of three-dimensional (3D) printed products. A post-printing processing device includes: (a) a sealable, matte black-painted chamber to minimize external light interference and enable evacuation; (b) a rotating platform with a brushless DC motor, spinning at 1000 to 6000 rpm, equipped with a custom 3D-printed Motor-to-Chuck Connector and a chuck to securely retain the 3D printed product, positioned in the sealable chamber; (c) a vacuum source operatively coupled to the chamber to evacuate the chamber during use; (d) a UV LED curing light; (e) a microcontroller and a GUI for precise control of spin rate and processing time; and (f) external mounts with a 20×20 cm aluminum extrusion frame for structural stability. The sealable chamber is configured to receive a 3D printed product for processing. The 3D printed product is attached and retained on the rotating platform. In one aspect, an attachment chuck is used to receive and retain the product for processing. A chuck, as used herein, is a specialized device used to securely attach an item to a machine or a component of a machine. Chucks come in various types depending on the specific application and the nature of the item being attached. Components of a chuck: A chuck typically consists of jaws or walls (usually three or more) that grip the item, a mechanism to adjust the jaws to accommodate different sizes, and a means to attach the chuck to the machine (such as a clip, a threaded connection, or a taper fit). In one example, the chuck jaws are adjusted or designed to the appropriate size to grip the item securely. Chucks are attached to the rotating platform using a specific mounting mechanism. This ensures that the chuck rotates with the rotating platform and maintains a stable grip on the attached item. Other attachment mechanisms can be used in place of the chuck.

The chamber has a base and a lid, wherein the lid can be engaged to seal the chamber, allowing evacuation of the chamber or application of a vacuum to reduce oxygen and air levels in the chamber. The term “vacuum” refers to a state where the pressure inside the chamber is significantly lower than atmospheric pressure. This condition is achieved by removing gases and other particles from the chamber, creating a partial or near-total absence of air or other gases. Vacuum is typically described in terms of pressure, often measured in units such as torr, Pascal (Pa), or millibar (mbar). The lower the pressure, the higher the vacuum level. Common vacuum ranges include high vacuum (pressure below 10⁻³ torr or 0.1 mPa), medium vacuum (pressure between 10⁻³ and 10 torr), and low vacuum (pressure between 10 and 10² torr). Examples of vacuum applications include high vacuum in space simulation chambers, medium vacuum in many industrial processes, and low vacuum in applications like vacuum packaging. A vacuum in a chamber is achieved by using vacuum pumps (such as rotary vane pumps, diffusion pumps, or turbomolecular pumps) to evacuate air and gases from the chamber. This process creates a controlled environment suitable for specific experiments, processes, or tests. Reduced oxygen levels reduce or minimize the inhibition of oxygen on the resin curing process. The rotating platform is configured to receive and retain a 3D printed product. In certain aspects, the rotating platform is rotated or spun during use to apply centrifugal force to a 3D printed product. In certain aspects, the rotating platform can be spun at 500 to 6000 rpm. In certain aspects, the 3D printed product is a microfluidic device.

In certain aspects, one or more curing lights are configured to illuminate the 3D printed product when desired. UV light curing of resin in 3D printing, also known as stereolithography (SLA) or digital light processing (DLP), is a step in the additive manufacturing process. The resin used in UV curing 3D printing is typically a photopolymer, which changes its properties from liquid to solid when exposed to UV light of a specific wavelength. The 3D printing process starts with a digital model sliced into layers. Each layer is then sequentially cured to build up the final 3D object. The UV light source (often a UV LED array or a UV laser, depending on the printing technology) selectively exposes the liquid resin in each layer according to the digital design. When UV light of the appropriate wavelength shines on the resin, it initiates a photochemical reaction called photopolymerization. This reaction causes the resin molecules to link together and solidify into a hardened polymer layer. The UV light is typically in the range of 350 to 420 nanometers (nm), which corresponds to the absorption spectrum of the photoinitiator molecules in the resin. This ensures efficient curing. The exposure time for each layer is precisely controlled to ensure sufficient curing without overexposing the resin, which could lead to undesirable properties such as brittleness. After the object is printed, some resin-based 3D prints may require additional curing to fully solidify and strengthen the material. This post-curing step can involve further exposure to UV light or heat, depending on the specific resin formulation and desired properties. In certain aspects, the curing light is a light emitting diode. In certain other aspects, the 395 nm UV LED curing light is configured to illuminate the 3D printed product, initiating photopolymerization. The matte black-painted chamber minimizes external light interference, enhancing curing efficiency. The brushless DC motor, controlled via a GUI, allows precise adjustment of spin rates (1000 to 6000 rpm), optimizing resin removal and surface smoothness for various device sizes.

The device includes a microcontroller configured to control the operation of the device components. In certain aspects, it includes a custom GUI configured to control the operation of the device components, including spin rate, and UV curing duration. External mounts and a 20×20 cm aluminum extrusion frame provide structural support, ensuring stability during high-speed spinning.

Certain embodiments are directed to methods for post-fabrication processing of a microfluidic device comprising: (a) applying a vacuum to a sealed chamber having a 3D printed product affixed to a rotating platform; (b) spinning the rotatable platform at a selected revolution rate; (c) exposing the 3D printed product to a curing light after unpolymerized resin has been removed by application of steps (a) and (b).

Other embodiments are directed to a transparent or smooth microfluidic chip produced by the post-fabrication processing of a 3D printed product described above. Quantifying the roughness of microfluidic device surfaces is crucial for understanding and optimizing their performance. Various techniques can be used to measure surface roughness: Atomic Force Microscopy (AFM) provides high-resolution images and precise measurements of surface topography down to the nanoscale. White Light Interferometry (WLI) measures surface height variations using interference patterns created by white light reflections. Optical Profilometry uses light or laser sources to measure surface profiles and roughness parameters. Scanning Electron Microscopy (SEM) offers detailed surface images that can be used to analyze roughness.

Several parameters are used to quantify roughness: Ra (Arithmetic Average Roughness) is the average deviation of the roughness profile from the mean line or centerline. Rq (Root Mean Square Roughness) is the root mean square of the roughness profile deviations. Rz (Maximum Height Roughness) is the difference between the highest peak and the lowest valley within the sampling length. Ry (Maximum Height of the Profile) is similar to Rz but considers the highest peak regardless of the lowest valley within the sampling length. RSm (Mean Peak Spacing) is the average distance between adjacent peaks and valleys.

Roughness affects fluid flow, especially in microchannels where surface interactions are significant. Rough surfaces increase frictional resistance, affecting flow rates and pressure drops. Rough surfaces can trap particles or biofilms, increasing contamination risks. Rough surfaces also promote biofilm formation, impacting long-term stability and reliability.

In certain aspects, the device comprises a sealable, matte black-painted desiccator chamber, a rotating platform driven by a brushless DC motor, a vacuum source, and a 395 nm UV LED curing light. The rotating platform, spinning at 1000 to 6000 rpm, applies centrifugal force to remove excess uncured resin, while the vacuum reduces oxygen inhibition, and the UV LED cures the print. A custom 3D-printed Motor-to-Chuck Connector secures the chuck, preventing detachment during high-speed spinning. A Graphic User Interface (GUI) enables precise control over spin rate and processing time. External mounts and a 20×20 cm aluminum extrusion frame provide structural stability. The method includes applying a vacuum, spinning the platform, and exposing the print to UV light, producing transparent microfluidic chips suitable for high-resolution applications.

Other embodiments of the invention are discussed throughout this application. Any embodiment discussed with respect to one aspect of the invention applies to other aspects of the invention as well and vice versa. Each embodiment described herein is understood to be an embodiment of the invention that is applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1A-1D. Characterization of microscopic imaging in microfluidic devices made using the traditional method. (A) The microchannel filled with 10.5 μm microbeads at 1.25× magnification. The device in (A) was fabricated using solvent washing, while in (B), these images show the same channels under fluorescent mode and zoomed in at 4× magnification. (C) Shows the image of 10.5 μm microbeads at 20× magnification under red fluorescent mode. (D) Characterizes the laminar flow interface between two buffer streams dyed with different colors.

FIG. 2. Calibration curve of the spinning motor: RPM vs. Voltage. The figure presents a linear correlation between different applied voltages and their resultant RPM. The voltages were measured using a digital multimeter, and the RPM values were recorded with a tachometer. The plotted data points confirm the predictability of motor speed in response to changes in voltage, allowing for precise control of the Spinning Desiccating Curer. Each data point is the average of three independent tests.

FIG. 3A-3D. Characterization of the post-processing method with and without the spinning and vacuuming steps. (A) A microfluidic chip successfully post-processed with the complete Spinning Desiccating Curing protocol. (B) A microfluidic chip post-processed using only spinning and no vacuuming. The external print surface is sticky and contaminated, indicative of incomplete curing. (C) A microfluidic chip post-processed with vacuuming and without spinning, resulting in blocked inlets, which suggests the presence of an uneven-layered resin on the surface. (D) A microfluidic chip post-processed without spinning and vacuuming, characterized by blocked channels, blocked outlets, and an overall glossy appearance.

FIG. 4A-4H. The 3D printing workflow incorporated with key steps to fabricate transparent microfluidic chips. (A) To ensure the dislodgement of prints and removal of surface imperfections left by support structures, a 63.5 μm layer of Kapton tape is applied to the build plate of the Phrozen 8K printer. (B) The prepared build plate is inserted into the 3D printer to complete the printing process. (C) The post-processing equipment, “Spinning Desiccating Curer,” includes a customized setup to spin the printed device within a vacuum-sealed desiccator, facilitating the removal of excess resin, while a 395 nm UV LED light cures the device. (D) The resulting print is a cleanly processed, transparent microfluidic chip. Characterization of microscopic imaging in microfluidic devices made by the Spinning Desiccating Curing method. (E) and (F) The microchannel filled with 10.5 μm microbeads at 1.25× magnification. The device in (E) was fabricated using the Spinning Desiccating Curing method. (F) These images show the same channels under fluorescent mode and zoomed in at 4× magnification. (G) Compares the image of 10.5 μm microbeads at 20× magnification under red fluorescent mode. (H) Characterizes the laminar flow interface between two buffer streams dyed with different colors.

FIG. 5A-5B. One example of a hardwire design of a post-processing device.

FIG. 6A-6C. Quantitative analysis of images taken from devices made by different methods. (A) Grayscale images of fluorescent microbeads imaged from devices made by the Spinning Desiccating Curing method (top) or by the traditional method (bottom). (B) The signal-to-noise ratio (SNR) of fluorescent microbead images taken from devices made by different methods. (C) The signal-to-background ratio (SBR) of the fluorescent microbead images taken from devices made by different methods. Inset: The average fluorescence signal intensity of microbeads imaged from devices made by different methods. N=10 in all quantifications (B and C).

FIG. 7A-7B. Hardware design of the upgraded Spinning Desiccating Curer for post-processing 3D printed microfluidic devices. (A) Illustrates a schematic cross-sectional view of the device, showing a vacuum-sealed, matte black-painted desiccator chamber containing a rotating platform driven by a brushless DC motor, capable of spinning at 1000 to 6000 rpm to apply centrifugal force to a 3D printed product. A custom 3D-printed Motor-to-Chuck Connector is screwed onto the motor, securely locking a custom 3D-printed chuck that holds the microfluidic device, preventing detachment during high-speed spinning. (B) Depicts the external structure, including external mounts and a 20×20 cm aluminum extrusion frame that houses the power supply, Arduino UNO R3 microcontroller, and upper mount supporting the desiccator. An internal 395 nm UV LED, mounted on a heatsink at the top of the desiccator, facilitates curing in a low-oxygen environment. A custom Graphic User Interface (GUI) is integrated with the microcontroller to provide precise control over spin rate and processing time, enhancing automation and reproducibility. The matte black paint on the desiccator minimizes external light interference, improving UV curing efficiency, while the brushless DC motor ensures smoother and more consistent resin layer formation compared to a repurposed CD player motor.

### DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

This disclosure describes a novel, cost-effective post-processing method for 3D printed microfluidic chips that achieves optical transparency without solvent washing, a common step in traditional 3D printing methods. This innovative approach is designed to facilitate 3D printing of microfluidic chips while achieving optimal transparency. This protocol introduces the “Spinning Desiccating Curing” technique, a novel approach to produce cost-effective, ready-to-use microfluidic devices.

Microfluidics are miniaturized devices used for handling small volumes of fluids at the microscale and are utilized for various applications, including environmental analysis, medical diagnostics, in vitro modeling of organs, and image-based screening (Aryal et al., Lab on a Chip, 2024, 24(5):1175-1206). Such miniaturized devices provide valuable instruments to efficiently perform operations like reactions, separations, and detection of various analytes in a high-throughput manner (Niculescu et al., International Journal of Molecular Sciences, 2021, 22(4):2011). Additive manufacturing (AM), known as 3D printing, has paved the way for a new horizon for microfluidics, enabling rapid device prototyping, offering unprecedented flexibility in device design, and reducing the requirement for specialized equipment and expertise. Typically, post-processing includes a solvent wash step and an additional UV curing step to clean and strengthen the printed object. However, an overlooked but critical aspect is that the porous nature of photo-crosslinked resin materials can result in the penetration and entrapment of these solvents in the print when alcohol-based washing solutions and resin-dissolving agents are used excessively (Dong et al., Nature Communications, 2021, 12(1)). This results in a cloudy, translucent appearance of the printed device. Additionally, the lack of transparency can also be attributed to non-smooth printing surfaces of the build plate and the use of support structures. Lastly, the presence of oxygen during the post-processing step can cause complications and contribute to the optical imperfection of the print surface, since molecular oxygen is known to inhibit radical-induced polymerizations due to its high reactivity toward radical species (Maafa, Polymers, 2023, 15(3):488). To address these issues, we introduce an integrated design to enable a simple, cost-effective, and generalizable post-processing method that removes excess resin without using solvents and produces optically transparent microfluidic devices made by Stereolithography (SLA) 3D printing. Our equipment, termed “Spinning Desiccating Curer” (short for “Spinning Desiccating Curing”), integrates a low-cost spinning motorized stage and a 395 nm UV LED light in a vacuum desiccator. The Spinning Desiccating Curer allows simultaneous expulsion of excess resin and creation of a smooth surface finish using centrifugal force. At the same time, the device is UV-cured under a low-oxygen environment. Additionally, we introduce a simple build plate modification method using a flexible polyimide film to eliminate the need for support structures during printing and reduce surface imperfections.

The scientific principle enabling the proposed technology is the use of spinning and vacuuming to utilize centrifugal force to create thin monolayers and degassing to expedite polymerization of wet monolayers. By various characterizations, we found that spinning 3D printed microfluidic chips removes all excess non-polymerized resin and that degassing the environment reduces the UV curing time, preventing warping of inner dimensions. These applied effects enable the proper post-processing of 3D printed microfluidic chips.

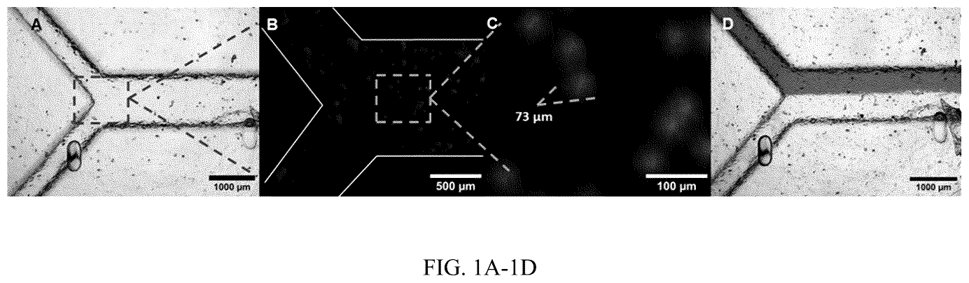

We characterized the imaging of microscopic objects in the microchannels using the traditional solvent washing method, as shown in FIG. 1. We flowed standard polystyrene microbeads (Magsphere Inc.) into a 700 μm microchannel for characterization. The microbeads are 10.5 μm in diameter and labeled with red fluorescence to benchmark the image in both brightfield and fluorescence modes. Under low-magnification brightfield imaging, the microfluidic chip made by the traditional solvent washing method (FIG. 1A) is significantly opaque. Upon zooming in and switching to fluorescent imaging mode (FIGS. 1B, 1C), the microbeads in red fluorescence show an undefined spherical shape with a blurry boundary in the device made by the solvent washing method. We quantitatively assessed the sharpness and image quality of the fluorescent microbead. The diameter of the single microbead imaged from this device is difficult to obtain due to the blurriness of the image and is significantly off from the expected size (measured to be 73 μm), not close to the 10.5 μm manufacturer specification. We demonstrated the ability to image fluid flow in the microfluidic device made by the solvent washing method. By flowing two streams of buffer filled with different dyes, we were able to observe a very blurry laminar flow interface in the device (FIG. 1D) as well as a non-uniform color of dyes due to the non-smooth surface and uncured resin on the interior surface of the microchannel.

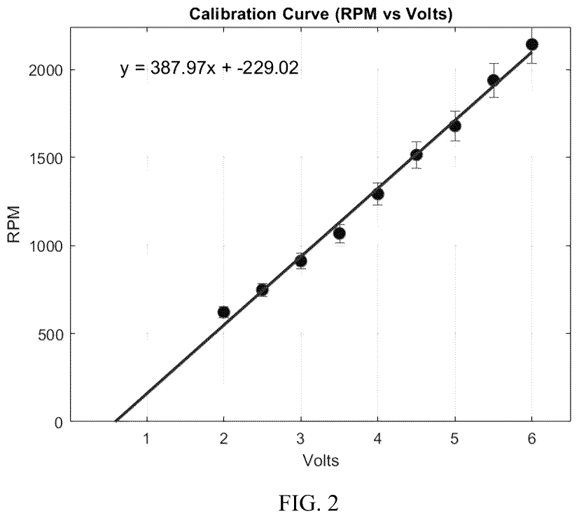

FIG. 2 illustrates how changing applied voltages to the spinning motor (e.g., a repurposed CD player motor) affects the spin rate of the motor. We sought to understand the relationship between applied voltage and spin rate (revolutions per minute, RPM). Controlling the motor's spin rate as it enables optimization of the protocol for a range of printed devices of different sizes. Our results show that we can precisely control the spin rate and estimate the desired RPM by the applied voltage through a linear relationship.

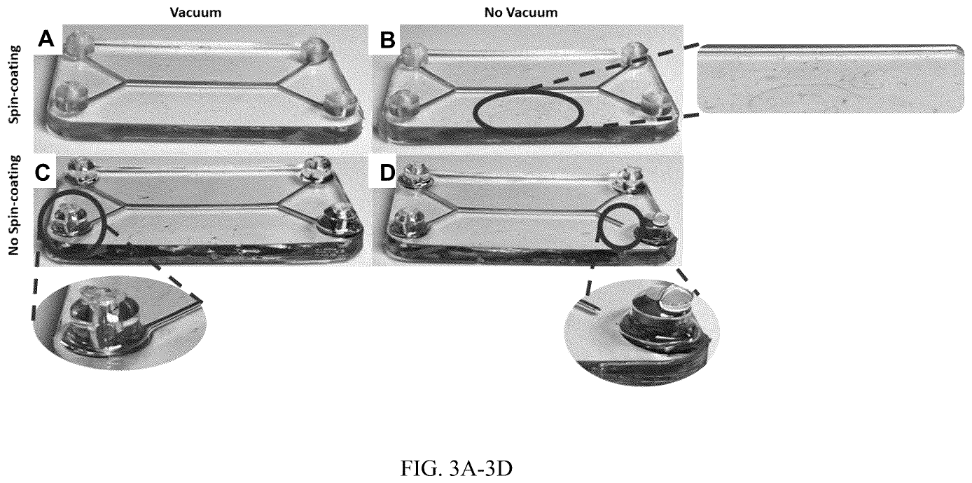

Next, we characterized the necessity of integrating spinning and vacuuming in post-processing methods. Four microfluidic devices, consisting of a simple bifurcated microchannel (height: 1.2 mm, width: 700 μm, length: 26 mm), were fabricated using different post-processing steps: (1) with spinning and vacuuming (FIG. 3A), (2) with spinning and without vacuuming (FIG. 3B), (3) without spinning and with vacuuming (FIG. 3C), and (4) without spinning and vacuuming (FIG. 3D). We found that without the vacuuming step in the post-processing (FIGS. 3B and 3D), the device exhibits a sticky external surface and is prone to attracting debris and dust on the surface (inset of FIG. 3B). This is due to the inefficient curing of the surface resin layer inhibited by oxygen. This suggests that the interior surface of the microchannel could also contain uncured resin, which could reduce transparency of the microchip, affect fluid flow, and contaminate samples in applications. Similarly, without the spinning step in the post-processing (FIGS. 3C and 3D), we found that the excess resin from the 3D printing could not be fully removed, resulting in blocked inlets and outlets (FIG. 3C) and blocked microchannels (FIG. 3D). Only when the post-processing integrated both vacuuming and spinning steps, could we achieve the complete removal and curing of the surface resin and create an optically clear and functional microfluidic device (FIG. 3A). The Spinning Desiccating Curer uses a brushless DC motor to drive a rotating platform at 1000 to 6000 RPM, replacing the previously used repurposed CD player motor. A custom 3D-printed Motor-to-Chuck Connector screws onto the motor, locking the custom 3D-printed chuck to prevent detachment during high-speed spinning. The motor is positioned at the center of a matte black-painted desiccator plate, with wires routed through a sealed hole to maintain a vacuum. The motor is controlled by a microcontroller (L293D) via an Arduino UNO R3, with a custom GUI for precise spin rate and timing control. A 395 nm UV LED, mounted on a heatsink at the desiccator's top, cures the device. External mounts and a 20×20 cm aluminum extrusion frame provide structural stability. This setup enables simultaneous spinning, vacuuming, and curing, producing optically transparent microfluidic chips.

Based on the enabling scientific principle, a device was designed for post-processing to achieve optical transparency in 3D printed microfluidic devices using centrifugal force and vacuum sealing, in the form of spinning inside a desiccator. This removes excess unpolymerized resin and allows for an even layering of the uncured liquid polymer on the device's surface and facilitates drying. The construction of the Spinning Desiccating Curer involved using a desiccator that creates a vacuum seal, degassing and breaking the oxygen inhibition layer that prevents the complete curing of 3D printed microfluidic chips. The proposed device utilizes a repurposed CD player motor, serving as a spinner, and is placed in the center of the desiccator plate. The wires powering and controlling the spinner motor of the CD player were routed out of the desiccator through a hole drilled in one side. The spinning motor's wires were then sealed with an epoxy sealant to maintain a full vacuum seal. The wires from the CD player's motor were connected to a microcontroller (L293D), which was controlled through an Arduino UNO R3. Additionally, a heatsink with an attached 395 nm UV LED was mounted on the inside top of the desiccator. This setup, which combines a desiccator, a spinner, and a UV LED, allows for the simultaneous and automatic execution of the post-processing steps. Finally, a custom 3D-printed chuck was fabricated to match the dimensions of a microfluidic device. This custom chuck was designed to attach seamlessly to the CD player's existing fitting, enabling the spinning process.

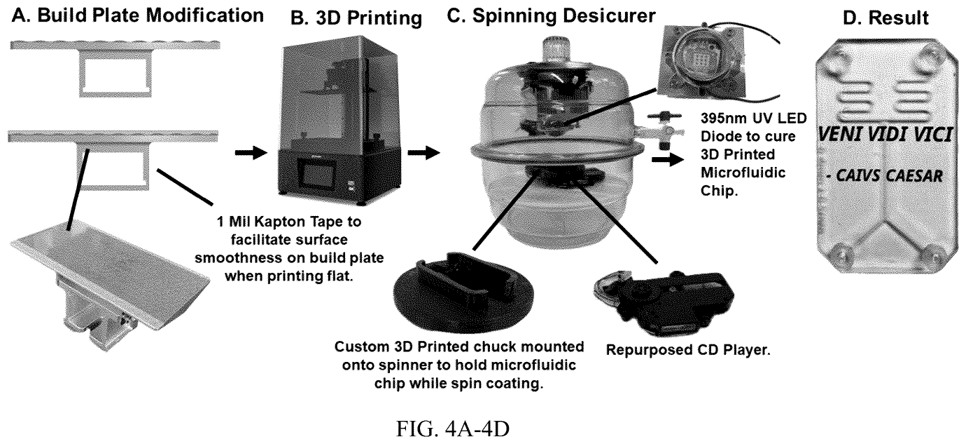

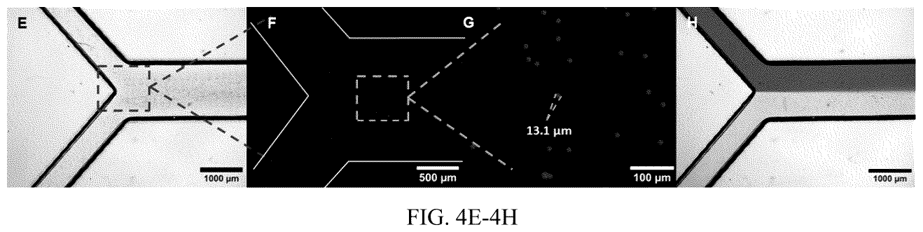

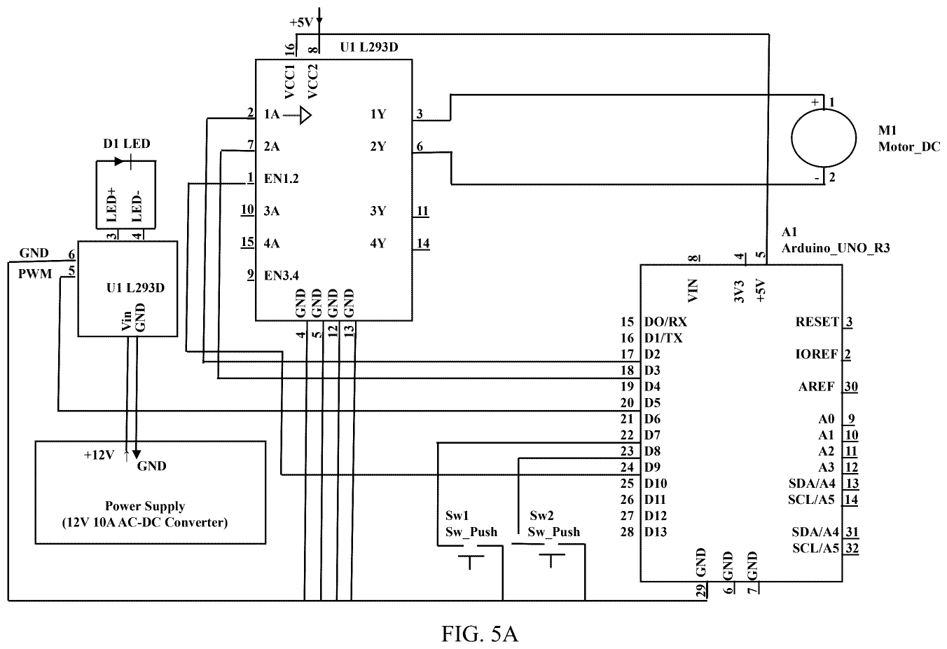

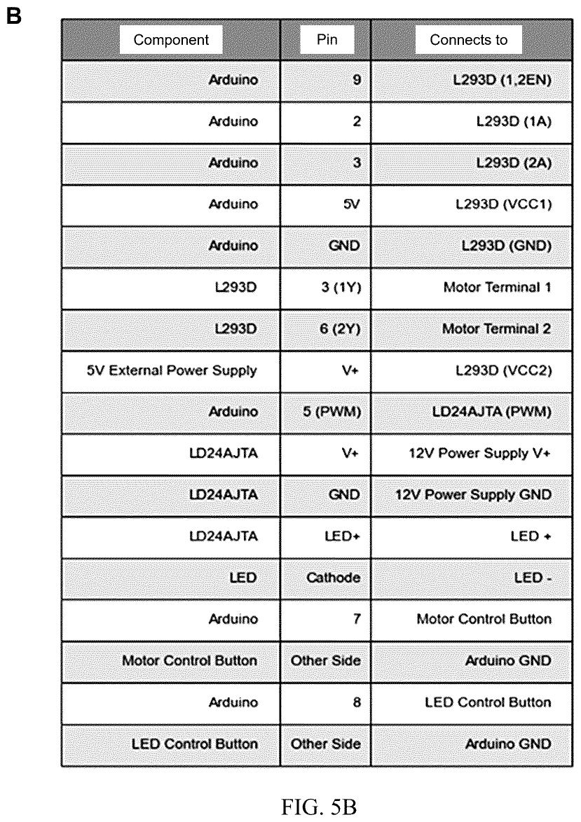

Furthermore, to demonstrate the importance of device optical transparency in microfluidic applications, we characterized the imaging of microscopic objects in the microchannels and compared the image quality in chips made by our Spinning Desiccating Curing method, as shown in FIG. 4. Similarly to FIG. 2, we embedded standard polystyrene microbeads into a 700 μm microchannel for characterization. The microbeads are 10.5 μm in diameter and labeled with red fluorescence. Under low-magnification brightfield imaging, the microfluidic chip made by our Spinning Desiccating Curing method (FIG. 4E) is significantly clearer compared to the traditional method (FIG. 1A). The microbeads are visible in our device even under low magnification. Upon zooming in and switching to fluorescent imaging mode (FIGS. 4F, 4G), the microbeads in red fluorescence show a clearly defined spherical shape with a sharp boundary in the device made by our method. We quantitatively assessed the sharpness and image quality of the fluorescent microbead. The diameter of the single microbead imaged from our device is about 13 μm, close to the 10.5 μm manufacturer specification. We also demonstrated the ability to image fluid flow in the microfluidic device made by our method. By flowing two streams of buffer filled with different dyes, we were able to observe a clear laminar flow interface in our device (FIG. 4H). Our results demonstrate that the microfluidic device made by the Spinning Desiccating Curing method has superb optical transparency for imaging the fine details of microscopic objects. The quality of our device is sufficient for most image-based microfluidic applications, such as phenotype-driven screening of cells and microorganisms.

Variation in microfluidic devices is expected to vary with different designs and applications. With that in mind, our novel approach of degassing and spin coating is generalizable to different print designs and brands of resin used. This method not only achieves optimal transparency for the respective brand of resin used but also significantly reduces the labor and time required for more traditional post-processing techniques. The device is easy to manufacture, has the potential to scale up, and is cost-effective. This device has a significant impact on creating microfluidic devices that optimize transparency and can be utilized for biomedical engineering purposes.

This invention can be commercialized for target customers, including biotechnology and pharmaceutical companies, as well as academic researchers. For biotechnology and pharmaceutical applications, this invention can be applied as a cost-effective technique for manufacturing 3D printed microfluidic chips for biomedical/chemical engineering purposes. This technology enables easy and fast reproducibility of microfluidic devices for cell sorting or microparticle isolation at a fraction of the cost and time required to manufacture microfluidic devices. For scientific researchers, this invention can be used as a general cell pretreatment device to provide high-quality live cell samples for many downstream biological assays, such as genetic sequencing and tissue culture.

Compared to previously reported post-processing methods for 3D printed devices and techniques, described embodiments have the following advantages: (i) Our Spinning Desiccating Curing method does not use any external solvents to remove excess unphotopolymerized resin that causes devices to become cloudy and reduces transparency. (ii) The device is easy to use and easy to manufacture, with the potential for high-throughput manufacturing. (iii) The post-processing method achieves optimal transparency in clear prints that is useful for microfluidic applications. (iv) To our knowledge, no prior technologies utilize spin coating and vacuum sealing to post-process 3D printed devices.

The device requires optimization to ensure total darkness inside the matte black-painted desiccator to minimize external light interference, enhancing UV curing efficiency. The operating method is streamlined by a custom GUI, allowing users to set spin rates (1000 to 6000 RPM) and processing times without manual intervention, improving reproducibility and ease of use.

One example of a processing protocol includes the following steps: (i) Insert the 3D printed device into the custom 3D-printed chuck on the spinner. The chuck can be replaced with other customized 3D-printed chucks if the device size varies. (ii) Connect the vacuum line to the desiccator to create a vacuum seal by turning on the vacuum line, and then activate the spinning motor for 3 minutes (RPM: 1710). This step aims to remove any excess resin on the surface of the chip by employing centrifugal movement. The simultaneous degassing process also eliminates the oxygen adsorption layer. (iii) Next, with continuous vacuum and spinning, turn on the UV LED for 4 minutes. This allows the device to be cured without any wet, uncured resin residue. The low-pressure environment in the vacuum chamber ensures no oxygen prevents the device from fully curing. (iv) Stop the operation, flip the device, and turn all functions on (spinner, vacuum seal, UV light) for 3 minutes. (v) At the end of this interval, switch off the UV LED and leave the device spinning and desiccating for an additional 3 minutes. This final step allows the 3D printed microfluidic chip to fully dry and be ready for use.

### EXAMPLES

The following examples, as well as the figures, are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Spinning Desiccating Curing: A Cost-Effective and Generalizable Post-Processing Method for Enhanced Optical Quality in 3D Printed Microfluidics

A. Materials and Methods To demonstrate the fabrication of microfluidic devices, we used 3D PRO-Crystal Clear Resin (Monocure3D) as an example resin material. We used a Phrozen Sonic Mini 8K Resin 3D Printer for the 3D printing to demonstrate our method; however, our method is compatible with any SLA 3D printer. To build the Spinning Desiccating Curer, we made the low-cost spinning stage/platform by repurposing a CD player (Hamilton HACX-114) in a vacuum desiccator (Cole-Parmer). To emphasize that our method can be easily translated, we deliberately sourced all the other components from Amazon, including a 12V 10A DC Universal Regulated Switching Power Supply (SMPS), alligator clips, a 5V 2A power supply adapter, an Arduino Basic Starter Kit, an Arduino UNO R3, an LED heatsink with a cooling fan, a 395 nm UV LED diode, and a 16 AWG power cord.

Procedure Overview: We first modified the build plate in the SLA 3D printer by affixing a layer of thin polyimide film using Kapton tape to enable flat printing of the device without support structures. The micrometer-scale thickness of the Kapton tape (63.5 μm) allows us to maintain the standard printing process without further modifications to the printer. After the standard printing process, we post-processed the printed device using the Spinning Desiccating Curer. We used a customized 3D-printed chuck to mount the device on the spinning motor made by a repurposed CD player. A UV LED light is attached to the top cap of a vacuum desiccator to complete the curing while the local oxygen is reduced by vacuuming. Our Spinning Desiccating Curer marks a significant departure from traditional post-processing techniques, streamlining the key final step to achieve highly transparent optical quality of the print. To print the microchannel with enhanced resolution.

The 3D printing workflow incorporates steps to fabricate transparent microfluidic chips. (A) To ensure the dislodgement of prints and removal of surface imperfections left by support structures, a 63.5 μm layer of Kapton tape is applied to the build plate of the Phrozen 8K printer. (B) The prepared build plate is inserted into the 3D printer to complete the printing process. (C) The post-processing equipment, “Spinning Desiccating Curer,” includes a customized setup where a CD player is repurposed to spin the printed device within a vacuum-sealed desiccator, facilitating the removal of excess resin, while a 395 nm UV LED light cures the device. (D) The resulting print is a cleanly processed, transparent microfluidic chip.

Build Plate Modification (Timing: 5 Minutes): Printing the device flat offers a substantial reduction in surface imperfections that typically result from using support structures. These supports are conventionally used in 3D printing designs to facilitate print removal from the build plate, which, however, leads to surface marks and indentations that are difficult to eliminate. While it is possible to sand and polish prints, this manual process is extremely time-consuming. Direct flat printing on glass slides could serve as an alternative; however, glass slide preparation can be labor-intensive, especially when following an iterative design and prototyping process. To address this issue, we attached a flexible polyimide film, Kapton tape, to the build plate. The incorporation of Kapton tape not only promotes a smoother surface finish but also enables effortless print separation from the build plate due to the flexibility of the Kapton tape. The detailed procedure to attach the Kapton tape to the build plate is as follows: (1) Clean the build plate platform with 70% isopropyl alcohol (IPA). Paper towels can be used to thoroughly dry the build plate. (2) Modify the build plate by carefully placing 1-mil Kapton tape on the surface of the build plate, ensuring no air bubbles are trapped on the surface. Air bubbles could lead to deformations on the surface of the print. (a) We recommend the use of a roller or flat plastic card (such as a credit card) to remove bubbles. (3) Secure the build plate to the printer and confirm that no air bubbles are present in the resin vat of the printer. Air bubbles in the resin vat could affect the print, especially the microchannel structures, and lead to incomplete prints. (a) Bubbles can be removed by either placing the vat in a desiccator or by manually pinching them with a sharp needle. (4) Confirm that the build plate is leveled. (5) The polyimide film can be reused for subsequent print jobs after thorough cleaning; however, it is good practice to change it after every use to avoid surface imperfections.

Building of Spinning Desiccating Curer (Timing: 5 Hours): Traditional solvent washing in the post-processing step can result in a translucent surface finish that significantly impairs device clarity. However, it is imperative to remove residual uncured resin from the print, especially if the device is used for biological samples. Therefore, we present an alternative strategy that uses centrifugal force to remove excess resin by spinning the print and creates a smooth and uniform layer of the uncured resin liquid on the device, both on the external surface and inside the channel structure. After removal of excess material, we polymerize the thin, smooth residual layer of uncured resin on the chip's surface directly in the Spinning Desiccating Curer. To minimize manual contact with the print, reduce post-processing time, and reduce oxygen inhibition, we integrated a desiccator with the motorized spinning stage and the light curing unit (UV LED). The Spinning Desiccating Curer efficiently performs two key tasks simultaneously: removing excess resin and curing the remaining uncured layer.

Hardware Assembly of the Spinning Desiccating Curer: The assembly of the Spinning Desiccating Curer included modifying a desiccator to establish a vacuum seal. This seal is crucial for degassing and reducing the oxygen inhibition during the curing of 3D printed microfluidic chips. We repurposed the CD player motor to function as a spinning motor, positioned at the center of the desiccator plate. The wires powering the spinner motor were routed out of the desiccator through a hole drilled on one side. The spinning motor's wires were then sealed with an epoxy sealant to maintain a full vacuum seal. The spinning motor was then connected to an external microcontroller (L293D) operated via an Arduino UNO R3 to control the spin rate. A heatsink coupled with a 395 nm UV LED was mounted on the desiccator's upper section using four drilled holes and screws. This setup configuration, integrating a desiccator, a spinning motor, and a UV LED, allows for the simultaneous and automatic execution of the post-processing with simple push-button operations and minimal manual intervention. Finally, a custom 3D-printed chuck was fabricated to match the dimensions of the intended microfluidic device. This custom chuck was designed to attach seamlessly to the CD player's existing mount to hold the device during the degassing, spinning, and curing process. Additionally, a calibration curve was plotted for the CD player's spinning motor, showing how changing applied voltages affects the spin rate of the motor. We sought to understand the relationship between applied voltage and spin rate (revolutions per minute, RPM). Controlling the motor's spin rate is vital, as it enables optimization of the protocol for a range of printed devices in different sizes. Our results show that we can precisely control the spin rate and estimate the desired RPM by the applied voltage through a linear relationship.

Custom Software and Interface: A custom Arduino script was developed to enable command execution through two buttons to control the UV LED and spinning motor. The UV LED, L293D controller, and Arduino microcontroller were powered through their own power supplies.

3D Print Design (Timing Varies): Despite the low cost and rapid turnaround of 3D printing for microfluidic device fabrication, its effectiveness could be limited by factors such as XY resolution and Z-height of void features. Existing research focuses on optimizing variables like photopolymer composition and light bleed-through control to achieve precise negative dimensional accuracies, particularly in the layer height above hollow channels for sub-millimeter devices. During the printing process, light could unintentionally penetrate or scatter into the uncured resin that is trapped in the negative features, causing accidental crosslinking. Therefore, it is important to note that a minimal overhang layer should be designed between the surface of the device and the channels to decrease the degree of overexposure or bleed-through light and improve print resolution. The choice of 3D-modeling software, slicing software, and 3D printer imposes no limitation on following this protocol. Our group uses a variety of modeling software (Solidworks, Onshape, AutoCAD) and the Chitubox slicer to demonstrate the printing on a Phrozen Sonic Mini 8K 3D printer. The detailed design process is as follows: (1) Design the chip to be printed. The overhang layer should be around 1 to 4 regular layers thick. The highest resolution of the microchannel may vary with the printer. (2) Export and load the STL file into the slicer software of choice. Slicers of choice include, but are not limited to, Chitubox, LycheeSlicer, and PrusaSlicer. (a) Slicer settings are dependent on the printer and resin. If the print fails to attach to the build plate, we recommend increasing both the bottom exposure time and the bottom layer count. If the print fails completely, other major parameters, such as exposure time, will need to be changed. Channel blockage is usually an indication of overexposure, while complete print failure is indicative of underexposure. (3) Export the print job, load it to the 3D printer, and then follow the steps in 2.2 build plate modification. By making the overhang layers as thin as possible, the risk of UV light bleed-through is mitigated, and channel dimensions are as small as the user may achieve. It is also important to have a minimum bottom layer number to account for the Kapton tape for the build plate modification.

Printing Process (timing ˜30-120 minutes): Our method is consistent with a well-established SLA printing process. Thanks to the micrometer-thickness of the thin polyamide film, we do not need any alterations to the printer and its software, which 'prevents any complications related to build platform leveling. The printing process is detailed as follows: 1. Load print job to printer and commence printing process. a. We recommend covering the 3D printer's removal casing with aluminum to avoid external light from affecting the printing job. 2. Once the print job is finalized, remove the build plate from the printer. The channels will usually be filled with unpolymerized resin; therefore, it is crucial to vacuum the uncured liquid. We recommend vacuuming the channels using either syringes or a house vacuum for at least 10 minutes. 3. Detach the print from the build plate by removing the Kapton tape from the build plate. The Kapton tape can then be easily removed from the print due to the flexibility of the thin film.

Post processing using Spinning Desicurer (timing 15 minutes): 1. Insert the 3D printed device into the custom 3D printed chuck. 2. Create vacuum seal, and then activate the spinning motor for 3 minutes (RPM: 1710). This step aims to remove any excess resin on the surface of the chip by employing centrifugal movement. The simultaneous degassing process also eliminates the oxygen adsorption layer. 3. Next, with continuous vacuum and spinning, turn on UV LED for 5 minutes. This allows for the device to be cured without any wet, uncured resin residue. The low-pressure air environment in the vacuum chamber will ensure no oxygen to prevent the device from fully curing. 4. Stop the operation, flip the device, and repeat steps 2 and 3. 5. At the end of this interval, switch off the UV LED and leave the device spinning and desiccating for an additional 2 minutes. This final step allows for the 3D printed microfluidic chip to fully dry and is ready for use.

### B. Results and Discussion

We characterized the necessity of the integration of spinning and vacuuming in our post processing method. Four microfluidic devices consisting of a simple bifurcated microchannel (height: 1.2 mm, width: 700 μm, length: 26 mm) were fabricated using different post processing steps: 1) with spinning and vacuuming with spinning and without vacuuming without spinning and with vacuuming without spinning and vacuuming. We found that without the vacuuming step in the post processing, the device shows a sticky external surface and is prone to attract debris and dust on the surface. It is due to the inefficient curing of the surface resin layer inhibited by oxygen. This suggests that the interior surface of the microchannel could also contain uncured resin, which could cause diminished transparency of the microchip, affect the fluid flow, and contaminate samples in applications. Similarly, without the spinning step in the post processing, we found the excess resin from the 3D printing could not be fully removed, which results in blocked inlets and outlets and blocked microchannels. Only when the post processing integrated both vacuuming and spinning steps, could we achieve the complete removal and curing of the surface resin and create an optically clear and functional microfluidic device.

To characterize the optical transparency, we compared the ability to faithfully image a pattern through a print made by our method (Kapton tape build plate modification and Spinning Desicurer post processing) with a print made by the traditional SLA method (support structure and solvent washing). We imaged the UTSA's Rowdy mascot logo through the microfluidic device made by our method and the traditional method. An obvious difference in clarity could be observed: the traditional method produced a noticeably blurrier image compared with the clean, sharper image achieved by our Spinning Desicurer method. To further quantitatively evaluate the transparency, we compared the Rowdy logo imaged through blank plates made by different methods with the control (imaged through a clear glass slide). We then developed a custom Python script to assess the image quality leveraging computer vision techniques. Our script matches key point descriptors in the Rowdy logo imaged through the printed plate to those of a control (through a clear glass slide), using the Scale-Invariant Feature Transform (SIFT) algorithm, a technique used for detecting and describing local features in images, paired with a Brute Force Matcher, an approach that compares descriptors in one image with all descriptors in another. We were able to quantitatively assess the feature visibility of the Rowdy logo and, by extension, the transparency of the printed plates. For each fabrication method, three images were analyzed against the control, obtaining an average “good matches” for each group. The print plates made by our method yielded an average of 323 ‘good matches’ whereas the traditional method exhibited an average of just 8 ‘good matches’. This quantification suggests a significant improvement in transparency of devices processed by our method.

At last, to demonstrate the importance of the device optical transparency in microfluidic applications, we characterized the imaging of microscopic objects in the microchannels and compared the image quality in chips made by our Spinning Desicurer method with the traditional solvent washing method. We flowed standard polystyrene microbeads (Magsphere Inc) into a 700 μm microchannel for characterization. The microbeads are 10.5 μm in diameter and labeled with red fluorescence to benchmark the image in both brightfield and fluorescence modes. Under low-magnification brightfield imaging, the microfluidic chip made by our Spinning Desicurer method is significantly clearer compared with the traditional method. The microbeads are visible in our device even under low magnification. Upon zooming in and switching to fluorescent imaging mode, the microbeads in red fluorescence show a clearly defined spherical shape with a sharp boundary in the device made by our method, as opposed to the blurred images obtained from the device made by the traditional method. The diameter of the single microbead measured from our device is about 13 μm, close to the 10.5 μm manufacturer specification; However, the diameter of the single microbead imaged from the traditionally made device is difficult to measure due to the blurriness of the image and is way off from the expected size (measured to be 73 μm). We also demonstrated the ability to image fluid flow in the microfluidic device made by our method. By flowing two streams of buffer filled with different dyes, we were able to observe a clear laminar flow interface in our device; However, the interface was blurry and the colors of dyes were not uniform from the traditionally made device due to the non-smooth surface and uncured resin on the interior surface of the microchannel.

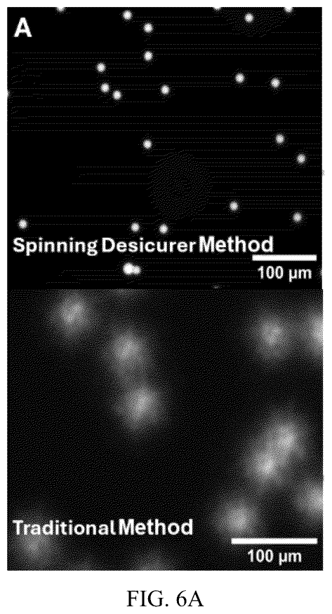

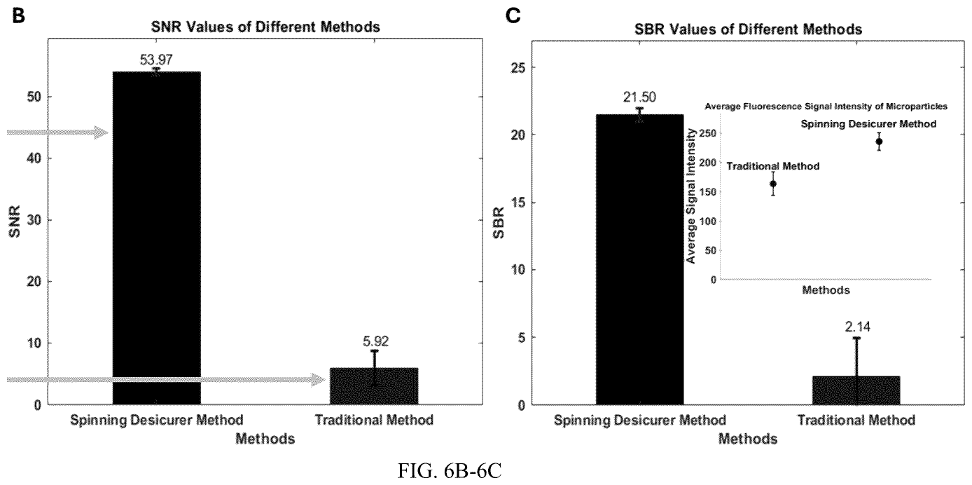

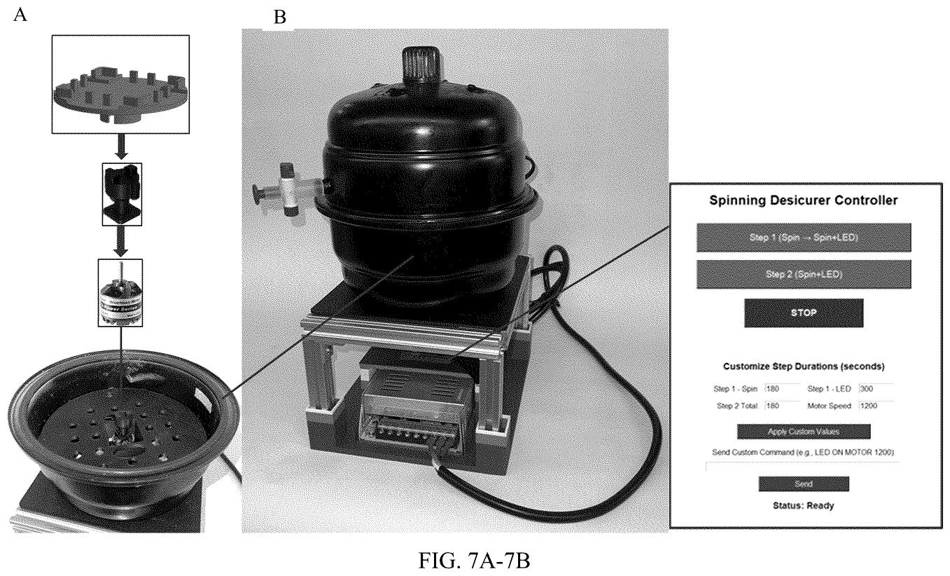

To quantitatively assess the image quality obtained from our device, we analyzed the signal-to-noise ratio (SNR) and the signal-to-background ratio (SBR) of the high-resolution fluorescent images. FIG. 6A shows the grey scale images of fluorescent microbeads imaged from devices made by our method and made by the traditional method. The SNR (FIG. 6B) of the fluorescent microbead image taken from our device (53.97) is almost an order of magnitude higher than the one taken from the traditionally made device (5.92), demonstrating that our method offers a much more transparent device with little scattering for clear fluorescence imaging. We further quantified the SBR and average fluorescence signal intensity of microbeads from both devices. The SBR of the fluorescent image taken from our device is also an order of magnitude better, and the average fluorescence intensity of the microbead is about 1.5 times higher (FIG. 6C inset). This is because our transparent device allows less energy loss of the emitted fluorescence by preventing light scattering and absorption at the device surface. A fluorescence signal peak can be easily found in the image taken from our device; whereas the fluorescence signal peak is overwhelmed in the background noise in the image taken from the traditionally made device. Our results demonstrate that the microfluidic device made by the Spinning Desicurer method has a superb optical transparency for imaging the fine details of microscopic objects; the quality of our device is sufficient in most image-based microfluidic applications such as phenotype-driven screening of cells and microorganisms.

We developed a novel, paradigm-shifting post processing method for SLA 3D printing to enable the fabrication of highly transparent microfluidic devices. Our method includes two key components: (1) modification of the 3D printing build plate by attaching flexible polyimide film to eliminate the need of supporting structures; (2) implementation of a new post processing equipment “Spinning Desicurer”. The Spinning Desicurer integrates a spinning motorized stage and a UV LED light into a vacuum sealed desiccator and addresses three post processing challenges simultaneously: (1) solvent-free removal of excess uncured resin, (2) creation of a smooth print surface free from optical defects, and (3) complete curing of the print surface by reducing inhibiting oxygen in the environment. Our method completely changed the post processing concept of SLA 3D printing by eliminating the need for solvent washing which greatly affects the optical transparency of the print due to the adsorption of the solvents and the generation of surface roughness. Our post processing method can be applied to not only SLA printing but also various other light-based 3D printing techniques, such as two-photon polymerization (TPP) 3D printing. TPP method has great potential in microfluidic manufacturing due to the micrometer level spatial resolution it offers. However, it could also suffer from surface roughness due to several factors including misalignments, resin shrinkage, and laser beam shadowing, which significantly affects the optical property of the printed device. Integrating our Spinning Desicurer as a post processing step could provide the solution to enhance the processing accuracy much needed for TPP 3D printing techniques. Our method can be executed using low-cost, easily accessible materials, circumventing expensive commercial apparatus, sophisticated printer modifications, and potential safety hazard of handling waste solvent. Since our method does not require customized formulation of the resin, it is generalizable and can be used for different resin materials such as biocompatible resin or hydrogels. We demonstrated that the optical transparency and the quality of the microfluidic device fabricated by our method are sufficient for imaging fine details of microflow and micrometer-scale objects. We hence envision that this novel method will be easily adopted in different labs and enable users to prototype microfluidic devices for high-resolution applications including but not limit to bioengineering, medical, and pharmaceutical fields, with minimal requirement in supplies and effort.

### Definitions

For the purposes of this specification and the appended claims, the following terms have the meanings set forth below unless the context clearly indicates otherwise:

3D Printed Product: An object fabricated using additive manufacturing techniques, such as stereolithography (SLA) or digital light processing (DLP), where a digital model is sliced into layers and sequentially cured to form a three-dimensional structure. In the context of this invention, a 3D printed product typically refers to a microfluidic device unless otherwise specified.

Microfluidic Device: A miniaturized device designed to manipulate small volumes of fluids, typically on the order of microliters or less, through microchannels with dimensions ranging from tens to hundreds of micrometers. Such devices are used for applications including, but not limited to, medical diagnostics, environmental analysis, and in vitro modeling.

Spinning Desiccating Curing: A post-processing method for 3D printed products that integrates centrifugal spinning, vacuum desiccating, and UV light curing to remove excess uncured resin, reduce oxygen inhibition, and achieve optical transparency in the final product, particularly microfluidic devices.

Rotating Platform: A component of the post-processing device that spins at controlled rates, typically between 1000 and 6000 revolutions per minute (RPM), to apply centrifugal force to a 3D printed product, facilitating the removal of excess uncured resin and creating a smooth surface finish.

Sealable Chamber: A vacuum-sealed enclosure, typically painted matte black to minimize external light interference, designed to house the rotating platform and 3D printed product during post-processing. The chamber is operatively coupled to a vacuum source to reduce oxygen and air levels, enhancing the curing process.

Vacuum: A state within the sealable chamber where the pressure is significantly lower than atmospheric pressure, achieved by removing gases and air using a vacuum pump. The vacuum reduces oxygen levels to minimize inhibition during resin curing, typically operating in the low to medium vacuum range (10 to 10² torr).

Curing Light: A light source, typically a 395 nm ultraviolet (UV) light-emitting diode (LED), used to initiate photopolymerization in the resin of a 3D printed product, transforming liquid resin into a solid polymer through exposure to UV light in the range of 350 to 420 nanometers.

Chuck: A specialized attachment device, often custom 3D-printed, designed to securely retain a 3D printed product on the rotating platform during high-speed spinning. The chuck typically includes adjustable jaws or walls and a mounting mechanism, such as a Motor-to-Chuck Connector, to ensure stable attachment.

Motor-to-Chuck Connector: A custom 3D-printed component that securely attaches the chuck to the brushless DC motor, preventing detachment during high-speed spinning and ensuring precise alignment of the 3D printed product.

Graphic User Interface (GUI): A software interface integrated with a microcontroller, such as an Arduino UNO R3, that allows precise control over the spin rate, vacuum application, and UV curing duration during the post-processing of 3D printed products.

Photopolymerization: A photochemical reaction initiated by UV light exposure, where liquid resin molecules link together to form a solid polymer layer, used in both the initial 3D printing process and the post-processing curing step.

Optical Transparency: The property of a microfluidic device that allows light to pass through with minimal scattering or absorption, enabling clear visualization of microscopic objects or fluid flow within microchannels, critical for applications such as image-based screening.

Excess Uncured Resin: Liquid photopolymer resin remaining on or within a 3D printed product after the initial printing process, which must be removed to achieve a smooth surface and optical transparency.

Kapton Tape: A flexible polyimide film, typically 63.5 micrometers thick, applied to the build plate of a 3D printer to facilitate flat printing without support structures, reducing surface imperfections and enabling easy print removal.

Centrifugal Force: The force applied to a 3D printed product by the spinning of the rotating platform, used to expel excess uncured resin and create a uniform, smooth resin layer on the device surface.

Oxygen Inhibition: The interference of molecular oxygen with the photopolymerization process, where oxygen reacts with radical species to inhibit resin curing, resulting in incomplete curing or sticky surfaces. This is mitigated by the vacuum environment in the sealable chamber.

1. A three-dimensional (3D) printing product processing device comprising:
(a) a sealable chamber configured to be evacuated during use;
(b) a rotating platform positioned in the sealable chamber, the platform operatively connected to a motor, the rotating platform is configured to receive and retain a 3D printed product and spin during use;
(c) a vacuum source operatively coupled to the chamber to evacuate the chamber during use; and
(d) a curing light configured to illuminate the 3D printed product when desired.

2. The device of claim 1, wherein the curing light is a light emitting diode.

3. The device of claim 1, wherein the curing light is a 395 nm UV LED curing light.

4. The device of claim 1, further comprising a microcontroller configured to control the operation of the device components.

5. The device of claim 1, further comprising a microcontroller and a Graphic User Interface (GUI) configured to control the spin rate and processing time of the device components

6. The device of claim 1, wherein the rotating platform further comprising a retention device configured to secure the 3D printed product during processing.

7. The device of claim 1, wherein the rotating platform is positioned in the sealable chamber, operatively connected to a brushless DC motor, the rotating platform configured to spin at 1000 to 6000 rpm to apply centrifugal force to a 3D printed product, the platform including a custom 3D-printed Motor-to-Chuck Connector and chuck to securely retain the 3D printed product.

8. The device of claim 1, wherein the processing device further comprises external mounts and a 20×20 cm aluminum extrusion frame providing structural stability.

9. The device of claim 1, wherein the sealable chamber is painted matte black configured to minimize external light interference.

10. The device of claim 1, wherein the brushless DC motor provides smoother and more consistent spinning compared to a repurposed CD player motor.

11. The device of claim 1, wherein the Motor-to-Chuck Connector is screwed onto the brushless DC motor to securely lock the custom chuck, preventing detachment during high-speed spinning.

12. The device of claim 1, wherein the matte black paint on the sealable chamber minimizes external light interference, enhancing UV curing efficiency.

13. A method for post-fabrication processing of a microfluidic manufacture comprising:
(a) applying a vacuum to a sealed chamber having a 3D printed product affixed to a rotating platform;
(b) spinning the rotatable platform at a selected revolutions per minute;
(c) exposing the 3D printed product to curing light after unpolymerized resin has been removed by application of steps (a) and (b).

14. A transparent microfluidic chip produced by the post-fabrication processing method of claim 13.

15. A method for post-fabrication processing of a microfluidic manufacture comprising:
(a) applying a vacuum to a sealed, matte black-painted chamber having a 3D printed product affixed to a rotating platform via a custom 3D-printed chuck;
(b) spinning the rotatable platform at 1000 to 6000 rpm using a brushless DC motor, controlled via a Graphic User Interface (GUI);
(c) exposing the 3D printed product to a 395 nm UV LED curing light after unpolymerized resin has been removed by application of steps (a) and (b);
(d) flipping the 3D printed product and repeating steps (a) to (c);
(e) spinning and desiccating the 3D printed product for an additional 2-3 minutes to ensure complete drying.

16. A transparent microfluidic chip produced by the post-fabrication processing method of claim 15.
